(19) United States
(12) Patent Application Publication
(10) Pub. No.: US 2007/0036105 A1
(43) Pub. Date: Feb. 15, 2007

(54) Apparatus and method for providing inter-piconet data communication in wireless personal area network

(76) Inventors: Young-Ae Chun, Daejon (KR); Ji-Eun Kim, Daejon (KR); Sang-Jae Lee, Daejon (KR); Sang-Sung Choi, Daejon (KR); Kwang-Roh Park, Daejon (KR)

Correspondence Address: LADAS & PARRY LLP, 224 SOUTH MICHIGAN AVENUE, SUITE 1600, CHICAGO, IL, 60604, US

(21) Appl. No.: 11/509,192

(22) Filed: Aug. 23, 2006

(30) Foreign Application Priority Data
Aug. 12, 2005 (KR) 10-2005-0119629

(51) Int. Cl. H04Q 7/00; H04J 3/06; H04L 12/56

(52) U.S. Cl. 370/329; 370/350; 370/400

(57) ABSTRACT

Provided is an apparatus and method for providing inter-piconet data communication in a wireless personal area network. The apparatus includes a piconet association unit, a superframe synchronization unit, a superframe synchronization unit, a DSPS (device synchronized power save) set creation unit, a piconet information announcement unit, a transfer data storage unit, and a data transfer unit. The piconet association unit confirms that a plurality of piconets are located on different channels, and performs a piconet association process. The superframe synchronization unit performs superframe synchronization between piconets. The DSPS set creation unit creates a DSPS set or joining an existing DSPS set. The piconet information announcement unit provides a device with information about another data-transferable piconet and devices belonging to the piconet. The transfer data storage unit receives and stores data requested to be transferred within a superframe. The data transfer unit transmits the stored data to the destination piconet.

### FIELD OF THE INVENTION

The present invention relates to an apparatus and method for providing multi-hop communication between piconets in a Wireless Personal Area Network (WPAN); and, more particularly, to an apparatus and method for providing multi-hop communication between piconets in a WPAN, which make it possible to provide an inter-piconet multi-hop communication function to a device located in an overlapping area between a plurality of piconets, using a power management mode without incurring a communication interference.

### DESCRIPTION OF RELATED ART

A Wireless Personal Area Network (WPAN) is a network for wirelessly connecting audio/video devices, computers, peripherals and the like that are located within a short radius of about 10 meters. The WPAN supports wireless communication between low-power portable multimedia devices to provide a variety of multimedia services.

The WPAN is configured to have one or more piconets each including two or more devices that are wirelessly connected to each other. Various types of piconets will now be described with reference to FIGS. 1 through 3.

FIG. 1 illustrates an example of a conventional piconet configuration of a WPAN.

Referring to FIG. 1, a piconet 100 includes a piconet coordinator (PNC) 110 and a plurality of devices 121, 122, 123 and 124.

The piconet coordinator 1 selects one of the devices 121, 122, 123 and 124, and the selected device manages uses a beacon frame to manage fundamental timing.

Using beacon information, the piconet coordinator 110 and the devices 121, 122, 123 and 124 communicate with each other in single-hop mode. For example, the fourth device 124 can directly communicate with the first device 121 through a link 131, but cannot communicate with the second device 122 through links 132 and 133.

FIG. 2 illustrates another example of a conventional piconet configuration of a WPAN.

Referring to FIG. 2, two piconets 210 and 220 share one channel with each other. The piconet 210 is a parent piconet, and the piconet 220 is a child piconet. The parent piconet 210 includes a piconet coordinator 215 and a plurality of devices 211, 212, 213 and 214, and the child piconet 220 includes a plurality of devices 221, 222, 223 and 224. The device 211 among the devices of the parent piconet 210 serves as a piconet coordinator of the child piconet 220. The device 211 serving as the piconet coordinator of the child piconet 220 is also referred to as a child piconet coordinator (CPNP).

In the parent piconet 210, the piconet coordinator 215 and the devices 211, 212, 213 and 214 communicate with each other in single-hop mode. Likewise, in the child piconet 220, the child piconet coordinator 211 and the devices 221, 222, 223 and 224 also communicate with each other in single-hop mode.

The child piconet coordinator 220 can perform single-hop communication with the devices 212, 213, 214 and 215 of the parent piconet 210 as well as the devices 221, 222, 223 and 224 of the child piconet 220. However, other devices than the child piconet coordinator 220 cannot communicate with the devices belonging to the other piconets, not only directly but also through the child piconet coordinator 222.

FIG. 3 illustrates a yet another example of a conventional piconet configuration of a WPAN.

Unlike the WPAN of FIG. 2 including the parent and child piconets, the WPAN of FIG. 3 includes three piconets 310, 320 and 330 that use different channels.

Referring to FIG. 3, devices 301, 302, 303 and 304 are located in a boundary region between two or more of the piconets 310, 320 and 330.

The piconets 310, 320 and 330 use different channels. Therefore, even the devices 301, 302, 303 and 304 in the boundary region cannot communicate with the other devices belonging to the piconet using the different channel, while they can perform single-hop communication with the other devices of their own piconet.

As described above, the conventional WPAN supports single-hop communication only in a single piconet. Therefore, it is impossible to provide communication between different piconets using the same channel and between different piconets using different channels.

### SUMMARY OF THE INVENTION

It is, therefore, an object of the present invention to provide an apparatus and method for providing multi-hop communication between piconets in a WPAN, which make it possible to provide an inter-piconet multi-hop communication function to a device located in an overlapping area between a plurality of piconets, using a power management mode without incurring a communication interference.

In accordance with an aspect of the present invention, there is provided an apparatus for providing inter-piconet data communication in a wireless personal area network, the apparatus including: a piconet association unit for confirming that a plurality of piconets are located on different channels based on beacon information received through a channel scan process, and performing a piconet association process over a corresponding channel of each piconet; a superframe synchronization unit for performing superframe synchronization between piconets through a piconet parameter change process; a DSPS (device synchronized power save) set creation unit for creating a DSPS set or joining a preexisting DSPS set; a piconet information announcement unit for providing each device of each piconet with a piconet information element that is information about another data-transferable piconet and devices belonging to the data-transferable piconet; a transfer data storage unit for receiving and storing data for requesting data transfer to another piconet, within a superframe corresponding to a wake beacon period of each piconet; and a data transfer unit for transmitting the stored data to the another piconet in multi-hop mode over a channel allocated according to the wake beacon period of the another piconet.

In accordance with another aspect of the present invention, there is provided a method for providing inter-piconet data communication in a wireless personal area network, the method including the steps of: a) confirming that a plurality of piconets are located on different channels based on beacon information received through a channel scan process at a predetermined device included in a piconet; b) performing a piconet association process over a corresponding channel of each of the piconets at the predetermined device; c) performing superframe synchronization between the piconets through a piconet parameter change process; d) creating a DSPS (device synchronized power save) set or joining a preexisting DSPS set; e) providing each device of each piconet with a piconet information element that is information about another data-transferable piconet and devices belonging to the data-transferable piconet; f) receiving and storing data for requesting data transfer to another piconet, within a superframe corresponding to a wake beacon period of each piconet; and g) transmitting the stored data to the another piconet in multi-hop mode over a channel allocated according to the wake beacon period of the another piconet.

### BRIEF DESCRIPTION OF THE DRAWINGS

The above and other objects and features of the present invention will become apparent from the following description of the preferred embodiments given in conjunction with the accompanying drawings, in which:

FIG. 1 illustrates an example of a conventional piconet configuration of a WPAN;

FIG. 2 illustrates another example of a conventional piconet configuration of a WPAN;

FIG. 3 illustrates a yet another example of a conventional piconet configuration of a WPAN;

FIG. 4 illustrates a piconet configuration of a WPAN in accordance with an embodiment of the present invention;

FIG. 5 is a block diagram of a data transferer for providing inter-piconet data communication in a WPAN in accordance with an embodiment of the present invention;

FIG. 6 is a flowchart illustrating a method for inter-piconet multi-hop communication in a WPAN in accordance with an embodiment of the present invention;

FIG. 7 illustrates a method for inter-piconet multi-hop communication in a WPAN in accordance with an embodiment of the present invention;

FIG. 8 illustrates the format of an MAC frame header in accordance with an embodiment of the present invention;

FIG. 9 illustrates the format of a capability information element in accordance with an embodiment of the present invention; and

FIG. 10 illustrates the format of a piconet information element in accordance with an embodiment of the present invention.

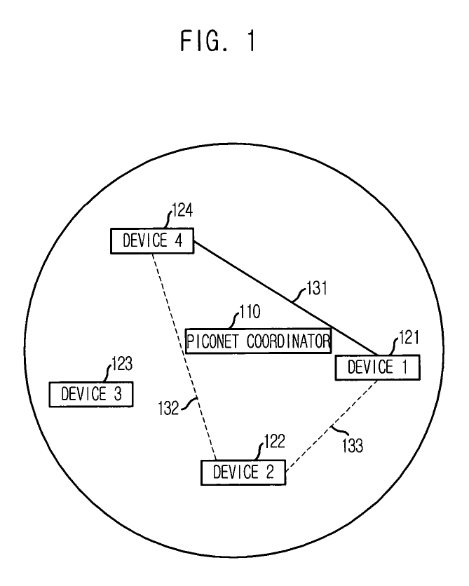

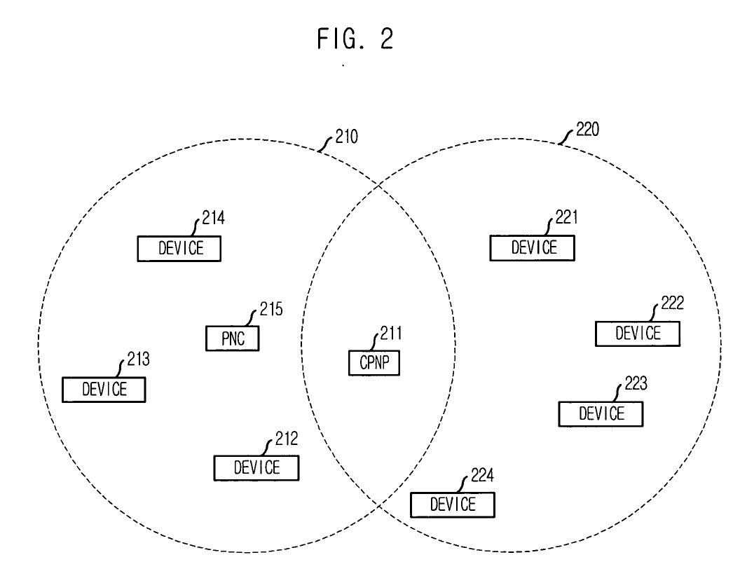

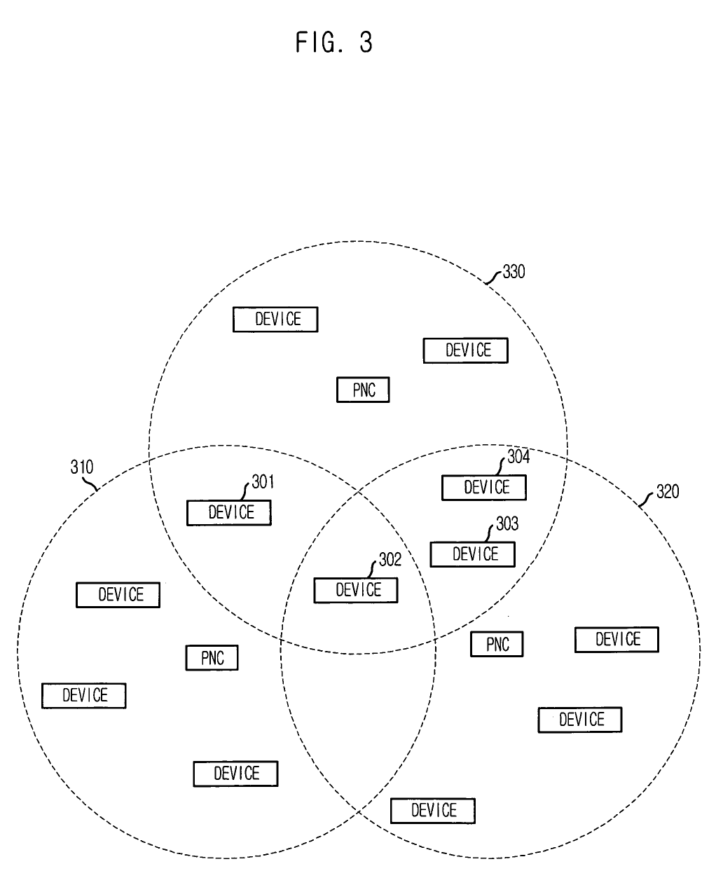

### DETAILED DESCRIPTION OF THE INVENTION

Other objects and aspects of the invention will become apparent from the following description of the embodiments with reference to the accompanying drawings, which is set forth hereinafter.

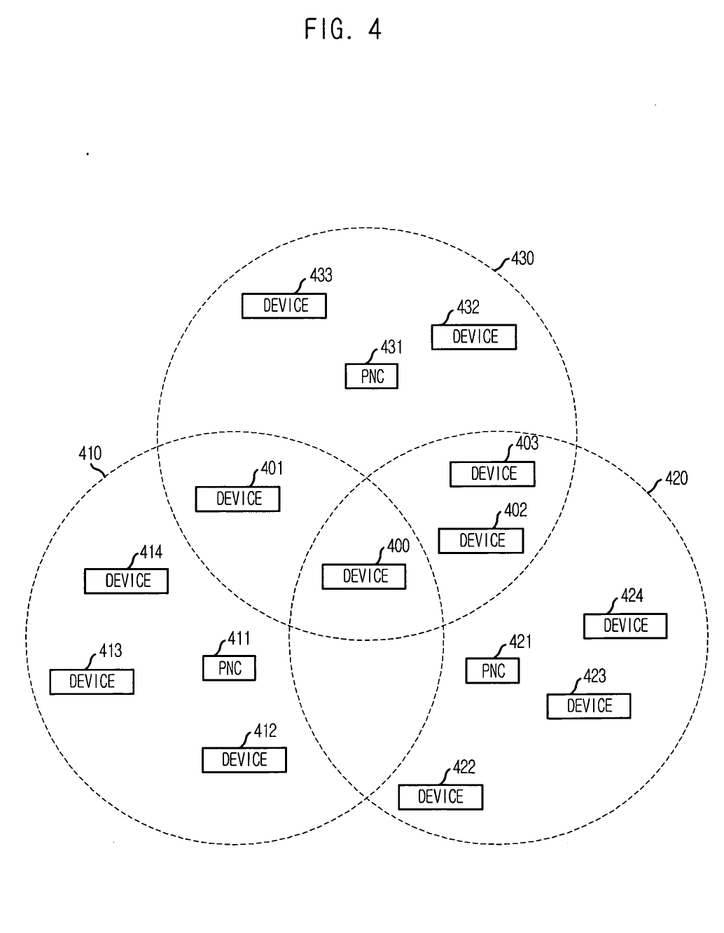

FIG. 4 illustrates a piconet configuration of a WPAN in accordance with an embodiment of the present invention.

In the drawing, three piconets 410, 420 and 430 use different channels.

The piconets 410 include a piconet coordinator 411 and a plurality of devices 400, 401, 411, 412, 413 and 414. The piconets 420 include a piconet coordinator 421 and a plurality of devices 400, 402, 403, 421, 422, 423 and 424. The piconets 430 include a piconet coordinator 431 and a plurality of devices 400, 401, 402, 403, 431, 432 and 433. The devices 400, 401, 402 and 403 are located in an overlapping area between two or more of the piconets 410, 420 and 430.

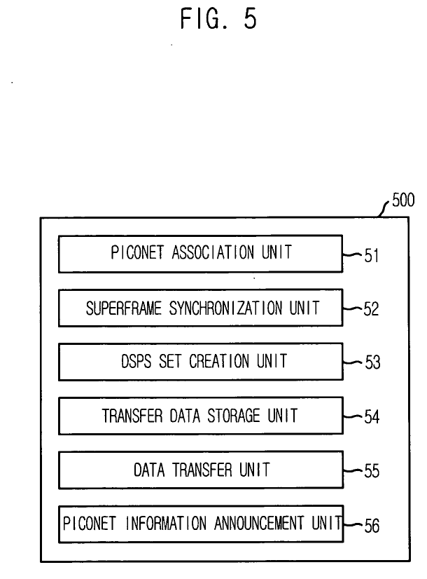

The device 400 is located in an overlapping area between the three piconets 410, 420 and 430, and is selected as a bridge device (BDEV) that mediates multi-hop communication between the piconets 410, 420 and 430. The bridge device 400 includes a data transferer 500 for providing multi-hop communication between the piconets 410, 420 and 430. The structure and function of the data transferer 500 will now be described in detail with reference to FIG. 5.

FIG. 5 is a block diagram of the data transferer 500 for providing inter-piconet data communication in a WPAN in accordance with an embodiment of the present invention.

Referring to FIG. 5, the data transferer 500 mounted on the bridge device 400 includes a piconet association unit 51, a superframe synchronization unit 52, a DSPS (device synchronized power save) set creation unit 53, a piconet information announcement unit 56, a transfer data storage unit 54, and a data transfer unit 55.

When the bridge device 400 verifies, from beacon information received through a channel scan process, that a plurality of piconets are located on different channels, the piconet association unit 51 performs a piconet association process over a corresponding channel of each piconet.

As a result, the bridge device 400 wakes not only during a superframe corresponding to a wake beacon (WB) of a specific piconet, but also during superframes corresponding to wake beacons of a plurality of other piconets to which it belongs. During the superframe corresponding to the wake beacon of the specific piconet, the bridge device 400 is recognized at the other piconets to be in sleep mode. Accordingly, the bridge device 400 can perform communication between two or more piconets by pretending to be in power management mode.

Through a piconet parameter change process, the superframe synchronization unit 52 performs superframe synchronization on a plurality of frames, that is, superframe synchronization between piconets.

Using a power save mode, the DSPS set creation unit 53 creates a DSPS set or joins a DSPS set corresponding to a preexisting power save period. At this point, the DSPS set creation unit 53 can suitably adjust a DSPS set according to the amount of traffic to be transferred between piconets. That is, the DSPS set creation unit 53 requests a channel time in consideration of the amount of transfer data of each piconet.

The piconet information announcement unit 56 provides each device of each piconet with a piconet information element (IE) that is information about another data-transferable piconet and devices belonging to the data-transferable piconet. This piconet information element will be described in detail later.

Within a superframe corresponding to a wake beacon period of each piconet, the transfer data storage unit 54 receives and stores data requested to be transferred from a device in a piconet to another piconet, which is a destination piconet.

Over a channel allocated according to the wake beacon period of the piconet, the data transfer unit 55 transmits the stored data to the destination piconet in multi-hop mode.

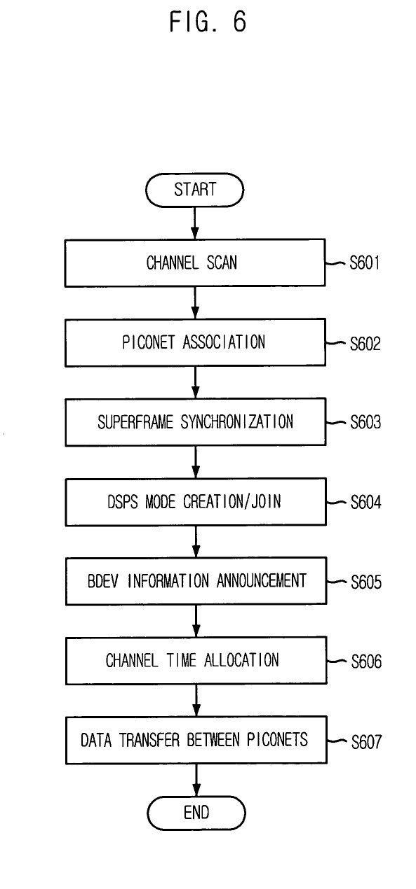

Hereinafter, a method by which the bridge device 400 performs inter-piconet multi-hop communication using the data transferer 500 will be described in detail with reference to FIG. 6.

FIG. 6 is a flowchart illustrating a method for inter-piconet multi-hop communication in a WPAN in accordance with an embodiment of the present invention.

Referring to FIG. 6, in step S601, the bridge device 400 verifies, from beacon information received through a channel scan process, that a plurality of piconets are located on different channels.

In step S602, using the piconet association unit 51, the bridge device 400 performs a piconet association process over the corresponding channel of each piconet. In step S603, information for superframe synchronization in the piconet association process is provided to each piconet to perform the superframe synchronization in each piconet through a piconet parameter change process.

In step S604, using a DSPS mode, the bridge device 400 creates a DSPS set corresponding to an optimal power save period or joins a DSPS set corresponding to an existing power save period. The DSPS mode is an example of a power management mode. At this point, using the DSPS set creation unit 53, the bridge device 400 can suitably adjust a DSPS set according to the amount of traffic to be transferred between piconets.

In step S605, the bridge device 400 announces information about neighboring piconets to the devices of overlapping piconets such that data can be transmitted between piconets. That is, through the association process of piconet association unit 51, the bridge device 400 provides each device of each piconet with a piconet information element (IE) that is information about another data-transferable piconet and devices belonging to the data-transferable piconet.

In steps S606 and S607, within a superframe corresponding to a wake beacon period of each piconet, the bridge device 400 performs single-hope communication in a piconet and receives and stores data requested to be transferred to another piconet. Thereafter, over a channel allocated according to the wake beacon period of the piconet, the bridge device 400 transmits the stored data to the destination piconet in multi-hop mode.

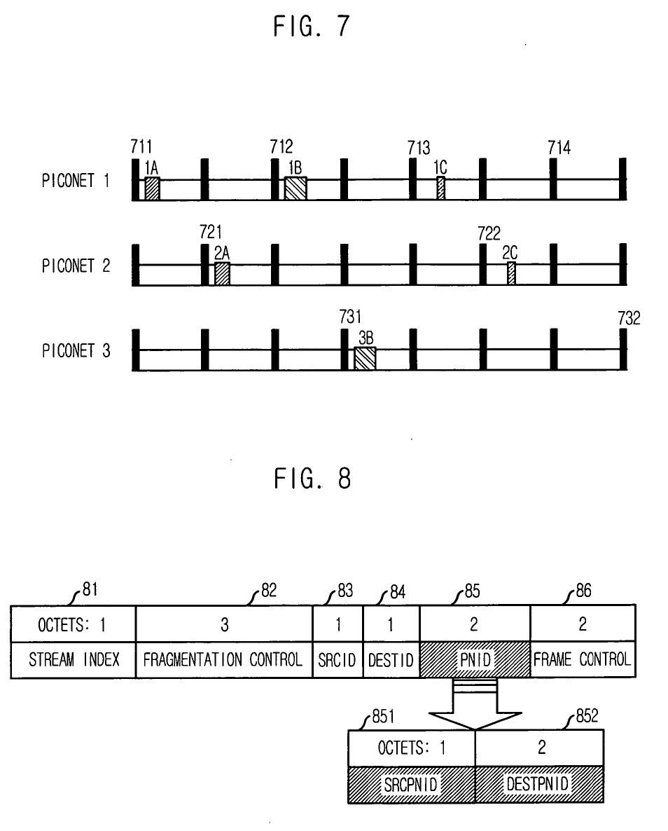

Hereinafter, the inter-piconet data transfer process of the bridge device 400 will now be described with reference to FIG. 7.

FIG. 7 illustrates a method for providing inter-piconet multi-hop communication in a WPAN in accordance with an embodiment of the present invention, which shows the structure of a superframe that is allocated by each piconet to the bridge device 400 in the WPAN environment illustrated in FIG. 4.

Referring to FIG. 7, the bridge device 400 are located in an area where first, second and third piconets overlap one another. The bridge device 400 joins a DSPS set of the first piconet with a wake beacon period of 2, a DSPS set of the second piconet with a wake beacon period of 4, and a DSPS set of the third piconet with a wake beacon period of 4.

During superframes corresponding to periods of wake beacons 711, 712, 713 and 714 of the first piconet, the bridge device 400 not only performs single-hop communication in the first piconet but also receives and stores data 1A, 1B and 1C requested to be transferred to another piconet.

Likewise, during superframes corresponding to periods of wake beacons 721 and 722 of the second piconet, the bridge device 400 not only performs single-hop communication in the second piconet but also receives and stores data 2A and 2C requested to be transferred from a device of the second piconet to another piconet.

Also, during superframes corresponding to periods of wake beacons 731 and 732 of the third piconet, the bridge device 400 not only performs single-hop communication in the third piconet but also receives and stores a data 3B requested to be transferred from a device of the third piconet to another piconet.

Meanwhile, the device 400 transmits the stored data over a channel that is allocated according to the wake beacon period of the corresponding piconet.

Hereinafter, the format of an MAC frame header for the above transmission will now be described in detail with reference to FIG. 8.

FIG. 8 illustrates the format of an MAC frame header in accordance with an embodiment of the present invention.

Referring to FIG. 8, an MAC frame header used in the present invention includes a stream index field (Stream Index) 81, a fragmentation control field (Fragmentation Control) 82, a source device ID field (SrcID) 83, a destination device ID field (DestID) 84, a piconet ID field (PNID) 85, and a frame control field (Frame Control) 86.

The piconet ID field 85 includes a source piconet ID field (SrcPNID) 851 and a destination piconet ID field (DestPNID) 852. The source device ID field 83 and the source piconet ID field 851 are used to represent source information. The destination device ID field 84 and the destination piconet ID field 852 are used to represent destination information.

When there are a plurality of bridge device candidates, which are mounted with the data transferer 500, in the overlapping area between the piconets, the priority to be a bridge device can be determined using the capability information element.

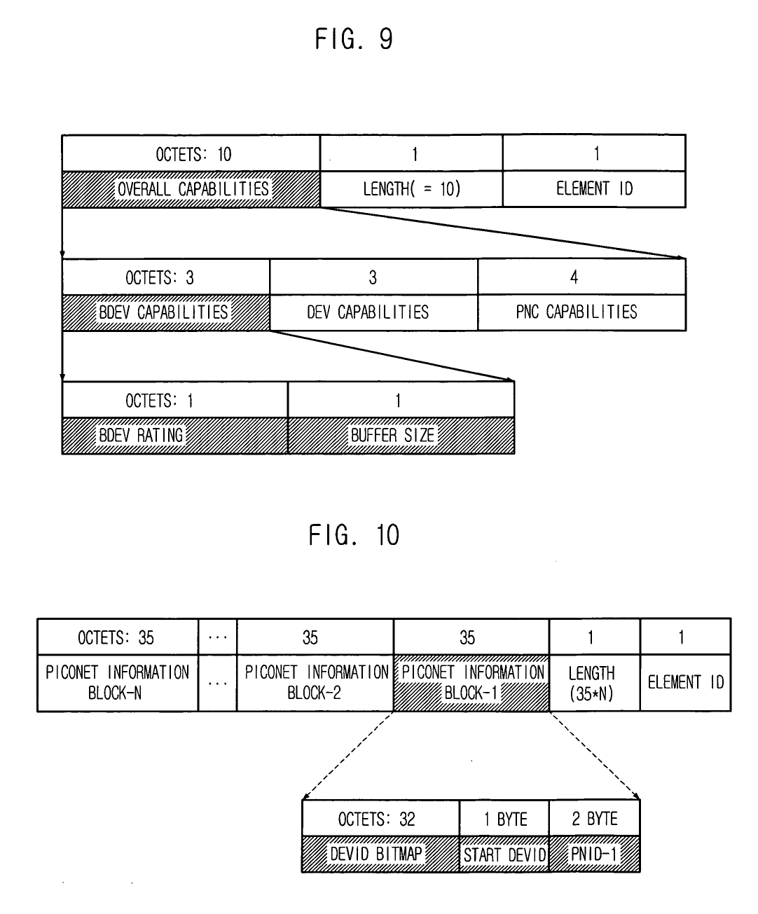

FIG. 9 illustrates the format of the capability information element in accordance with an embodiment of the present invention.

Referring to FIG. 9, a capability information element used in the present invention includes device capabilities (DEV Capabilities), piconet coordinator capabilities (PNC Capabilities), and bridge device capabilities (BDEV Capabilities). A bridge capabilities field 900 includes a BDEV rating field 91 and a buffer size field 92 that are used to the priority of the bridge device performing inter-piconet data transfer.

FIG. 10 illustrates the format of a piconet information element in accordance with an embodiment of the present invention.

Referring to FIG. 10, the piconet information element includes: information about a piconet to which the bridge device can transmit data directly or indirectly; and information about devices belonging to each piconet. That is, the piconet information element includes a plurality of piconet information blocks, and each of the piconet information blocks includes a device ID bitmap (DEVID Bitmap), a start device ID (Start DEVID), and a piconet ID (PNID).

According to the present invention, in the WPAN environment where one or more piconets each including a plurality of device and a piconet coordinator overlap each other, the inter-piconet multi-hop communication between piconets can be performed using a power management mode without incurring communication interference.

The methods in accordance with the embodiments of the present invention can be written as computer programs and can be implemented in general-use digital computers that execute the programs using a computer readable recording medium. Examples of the computer readable recording medium include magnetic storage media, optical recording media, and storage media such as carrier waves, for example, transmission through the Internet. Examples of the magnetic storage media include ROM, floppy disks, and hard disks. Examples of the optical recording medial include CD-ROMs and DVDs.

As described above, the present invention makes it possible to provide an inter-piconet multi-hop communication function to a device, which is located in an overlapping area between a plurality of piconets, using a power management mode without incurring a communication interference. Accordingly, it is possible to greatly enhance the resource efficiency between piconets.

The present application contains subject matter related to Korean patent application No. 2005-0119629, filed with the Korean Intellectual Property Office on Dec. 8, 2005, the entire contents of which is incorporated herein by reference.

While the present invention has been described with respect to certain preferred embodiments, it will be apparent to those skilled in the art that various changes and modifications may be made without departing from the scope of the invention as defined in the following claims.

What is claimed is:

1. An apparatus for providing inter-piconet data communication in a wireless personal area network, the apparatus comprising:
a piconet association unit for confirming that a plurality of piconets are located on different channels based on beacon information received through a channel scan process, and performing a piconet association process over a corresponding channel of each piconet;
a superframe synchronization unit for performing superframe synchronization between piconets through a piconet parameter change process;
a DSPS (device synchronized power save) set creation unit for creating a DSPS set or joining an existing DSPS set;
a piconet information announcement unit for providing each device of each piconet with a piconet information element that is information about another data-transferable piconet and devices belonging to the data-transferable piconet;
a transfer data storage unit for receiving and storing data requested to be transferred to another piconet, which is a destination piconet, within a superframe corresponding to a wake beacon period of each piconet; and
a data transfer unit for transmitting the stored data to the destination piconet in multi-hop mode over a channel allocated according to the wake beacon period of the destination piconet.

2. The apparatus as recited in claim 1, wherein during a superframe corresponding to a wake beacon of a predetermined piconet, the predetermined piconet is recognized at the other piconets to be in sleep mode.

3. The apparatus as recited in claim 1, wherein the DSPS set creating unit adjusts a DSPS set according to the amount of traffic to be transferred between piconets.

4. The apparatus as recited in claim 3, wherein through the association process of the piconet association unit, the piconet information announcement unit provides each device of each piconet with a piconet information element including information about another data-transferable piconet, which is a destination piconet, and devices belonging to the data-transferable piconet.

5. The apparatus as recited in claim 4, wherein the data requested to be transferred to the destination piconet comprises an MAC frame, and a header of the MAC frame includes a stream index field (Stream Index), a fragmentation control field (Fragmentation Control), a source device ID field (SrcID), a destination device ID field (DestID), a piconet ID field (PNID), and a frame control field (Frame Control).

6. The apparatus as recited in claim 5, wherein when a plurality of inter-piconet data communication providing apparatuses exist in an overlapping area between the piconets, and a priority among the apparatuses is determined based on a capability information element including a rating data and a buffer size data.

7. A method for providing inter-piconet data communication in a wireless personal area network, the method comprising the steps of:
a) confirming that a plurality of piconets are located on different channels based on beacon information received through a channel scan process at a predetermined device included in a piconet;
b) performing a piconet association process over a corresponding channel of each of the piconets at the predetermined device;
c) performing superframe synchronization between the piconets through a piconet parameter change process;
d) creating a DSPS (device synchronized power save) set or joining a preexisting DSPS set;
e) providing each device of each piconet with a piconet information element that is information about another data-transferable piconet and devices belonging to the data-transferable piconet;
f) receiving and storing data requested to be transferred to another piconet, which is a destination piconet, within a superframe corresponding to a wake beacon period of each piconet; and
g) transmitting the stored data to the destination piconet in multi-hop mode over a channel allocated according to the wake beacon period of the another piconet.

8. The method as recited in claim 7, further comprising the step of adjusting a DSPS set according to the amount of traffic to be transferred between piconets.

9. The method as recited in claim 7, wherein during a superframe corresponding to a wake beacon of a predetermined piconet, the predetermined device is recognized at the other piconets to be in sleep mode.

10. The method as recited in claim 9, wherein a piconet information element including information about another data-transferable piconet and devices belonging to the data-transferable piconet is provided to each device of each piconet through the association process in the step e).

11. The method as recited in claim 10, wherein the data requested to be transferred to the another piconet comprises an MAC frame, and a header of the MAC frame includes a stream index field (Stream Index), a fragmentation control field (Fragmentation Control), a source device ID field (SrcID), a destination device ID field (DestID), a piconet ID field (PNID), and a frame control field (Frame Control).

12. The method as recited in claim 11, wherein when a plurality of data transferers exist in an overlapping area between the piconets, and a priority among the data transferers is determined based on a capability information element including rating data and buffer size data.
